(19) United States
(12) Patent Application Publication
(10) Pub. No.: US 2015/0106644 A1
(43) Pub. Date: Apr. 16, 2015

(54) REDUNDANT ARRAY OF INDEPENDENT DISKS STORAGE DEVICE, SERVER SYSTEM, AND POWER MANAGEMENT METHOD THEREOF

(71) Applicant: WISTRON CORP., NEW TAIPEI CITY (TW)

(72) Inventors: CHIEH-YI LIN, NEW TAIPEI CITY (TW); MING-SHENG WU, NEW TAIPEI CITY (TW); CHIH-HUNG YEN, NEW TAIPEI CITY (TW)

(73) Assignee: WISTRON CORP., NEW TAIPEI CITY (TW)

(21) Appl. No.: 14/188,032

(22) Filed: Feb. 24, 2014

(30) Foreign Application Priority Data
Oct. 16, 2013 (TW) 102137297

(51) Int. Cl. G06F 11/30

(52) U.S. Cl. CPC G06F 11/3062; G06F 11/3034
USPC 713/340

(57) ABSTRACT

A redundant array of independent disks (RAID) storage device, a server system, and a power management method thereof are provided. The RAID storage device includes a plurality of hard disks, a plurality of fans, a power detector, and an expander control unit. The power detector is used for detecting the power consumption of the RAID storage device. The expander control unit is electrically connected to the hard disks, the fans, and the power detector. The expander control unit has a power control application which enables a user to configure an upper power consumption limit. When the power consumption of the RAID storage device exceeds the upper power consumption limit, the expander control unit executes a power management procedure so that the power consumption of the RAID storage device is lower than the upper power consumption limit.

### BACKGROUND

1. Technical Field

The present disclosure relates to a storage device, in particular, to a redundant array of independent disks storage device, a server system, and a power management method thereof.

2. Description of Related Art

As network communications technology advances, various demands for data transfer and large storage space increases as well. Because the RAID (redundant array of independent disks storage) device has advantage of a large storage capacity, the RAID storage device has been widely used for external storage devices or logical storage units for a computer system (e.g., server). Conventional RAID storage device generally comprises of a plurality of hard disks, a backup battery, a control unit, and fans, and all of the aforementioned components are in practice integrated and being disposed in a computer chassis. The RAID storage device utilizes the RAID technology, such as JBOD (Just a Bunch of Disk), RAID-0, or RAID-1 and combines a plurality of hard disks into a large RAID storage disk having high logical storage capacity for the purposes of data accessing improvement.

However, in order to insure the practical usability of the power supply for powering server and RAID storage device, not only it is necessary to construct a backup power supply that can stably support the operation of storage system, under which servers and RAID storage devices operate, the supplying power for the storage system must also be configured based on maximum power consumption drawn by servers and RAID storage devices estimated. So that the operational stability of server and RAID storage devices can be ensured.

Even though existing server can use power capping technique and dynamically control the power supplied to the server as well as the upper limit of the power supplied thereto to lower down the power consumption of the server. However, currently there is no power capping equivalent technology used for the RAID storage device. A person with ordinary skill in the art should know access operations of each hard disk in the RAID storage device may be different. Therefore, it is known that the RAID storage device does not always operate in the full operational state. As a result, estimating the supplying power for the RAID storage device with maximum power consumption thereof not only result in unnecessary waste of supplying power, but also limits the number of the RAID storage devices that the storage system can support, thereby reduce the overall storage capacity of the RAID storage device in the storage system.

### SUMMARY

Accordingly, an exemplary embodiment of the present disclosure provides a redundant array of independent disks storage device (RAID) storage device, a server system, and a power management method thereof. The RAID storage device can dynamically adjust the operation mode thereof according to a predetermined upper power consumption limit configured, so that the power consumption of the RAID storage device is lower than the upper power consumption limit. Thereby, increase power allocation efficiency for the RAID storage device.

An exemplary embodiment of the present disclosure provides a RAID storage device which includes a plurality of hard disks, a plurality of fans, a power detector, and an expander control unit. The expander control unit is coupled to the hard disks, the fans, and the power detector. The expander control unit has a power control application that enables a user to configure an upper power consumption limit. When the power consumption of the RAID storage device exceeds the upper power consumption limit, the expander control unit executes a power management procedure so that the power consumption of the RAID storage device is lower than the upper power consumption limit.

An exemplary embodiment of the present disclosure provides a server system, which includes a plurality of the RAID storage devices and at least a server. The server is coupled to the RAID storage devices. Each of the RAID storage devices is configured to have an upper power consumption limit for limiting the power consumption of each of the RAID storage devices. Each of the RAID storage devices includes a plurality of hard disks, a plurality of fans, a power detector, and an expander control unit. The expander control unit is coupled to the hard disks, the fans, and the power detector. The expander control unit has a power control application that enables a user to configure an upper power consumption limit associated with each RAID storage device. When the power consumption of the RAID storage device exceeds the respective upper power consumption limit, the expander control unit executes a power management procedure so that the power consumption of the RAID storage device is lower than the respective upper power consumption limit.

An exemplary embodiment of the present disclosure provides a power management method of a RAID storage device, wherein the RAID storage device includes a plurality of hard disks, a plurality of fans, a power detector, and an expander control unit. The power management method includes the following steps. A power control application is provided to enable a user to configure an upper power consumption limit, wherein the power control application is stored in the expander control unit. Next, whether the power consumption of the RAID storage device exceeds the upper power consumption limit is determined. When the power consumption of the RAID storage device exceeds the upper power consumption limit, the expander control unit executes a power management procedure so that the power consumption of the RAID storage device is lower than the upper power consumption limit.

In summary, exemplary embodiments of the present disclosure provide a RAID storage device, a server system, and a power management method thereof. When the power consumption of the RAID storage device exceeds a maximum upper power consumption limit configured, the RAID storage device is automatically driven to enter a power-saving mode, which includes reducing the switching frequency of the hard disks, reducing the access frequency of the hard disks, and reducing the rotational speeds of the fans to reduce the power consumption of the RAID storage device. Additionally, when the power consumption of the RAID storage device is lower than a lower power consumption limit, the RAID storage device is operable to enhance the performance of the RAID storage device. Accordingly, the RAID storage device can fully and efficiently utilize the supplying power allocated by actively and dynamically configuring the operation mode, thereby avoid unnecessary waste of supplying power.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of a RAID storage device provided in accordance to a first exemplary embodiment of the present disclosure.

FIG. 2 is a block diagram of a server system provided in accordance to a second exemplary embodiment of the present disclosure.

FIG. 3 is a block diagram of a server system provided in accordance to a third exemplary embodiment of the present disclosure.

FIG. 4 is a flowchart diagram illustrating a power management method of a RAID storage device provided in accordance to a fourth exemplary embodiment of the present disclosure.

FIG. 5-1 and FIG. 5-2 are flowchart diagrams respectively illustrating a power management procedure of the power management method provided in accordance to the fourth exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

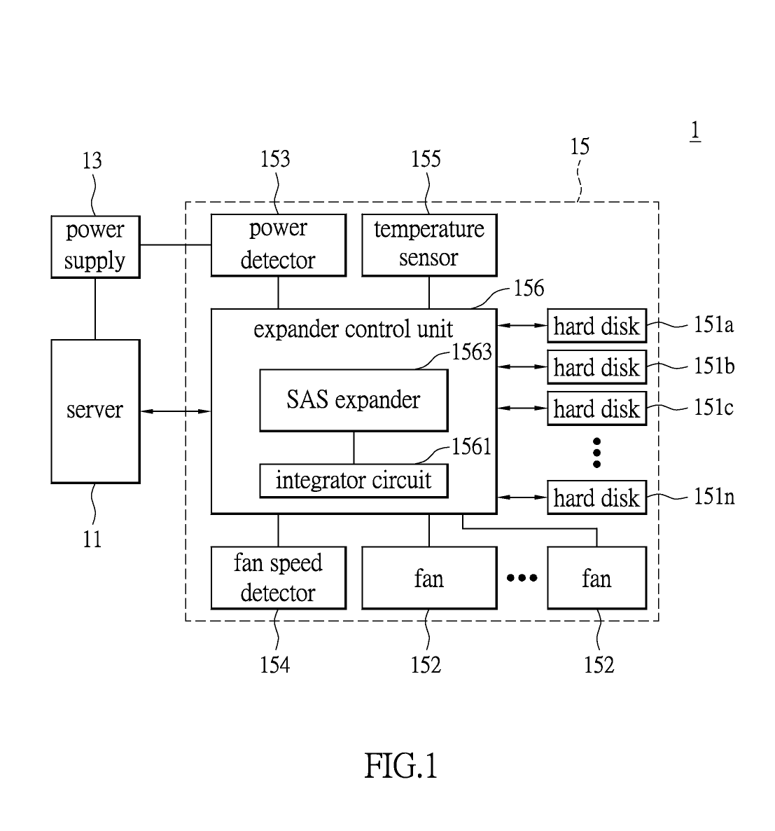

Please refer to FIG. 1, which shows a block diagram illustrating a RAID storage device provided in accordance to a first exemplary embodiment of the present disclosure. The server system 1 includes a server 11, a power supply 13, and a RAID storage device 15. The power supply 13 is electrically connected to the server 11 and the RAID storage device 15, respectively.

The server 11 is electrically connected to the RAID storage device 15 through a first transmission interface, e.g., Serial-attached Small Computer System Interface (SAS), to perform data storage operations. The power supply 13 is configured to supply the necessary power to support the operations of the server 11 and the RAID storage device 15. The power supply 13 in practice supplies power in the kilowatt range for all the hard disks 151a˜151n in the RAID storage device 15 to operate stably.

The RAID storage device 15 further includes a plurality of hard disks 151a˜151n, a plurality of fans 152, a power detector 153, a fan speed detector 154, a temperature sensor 155, and an expander control unit 156. The expander control unit 156 is electrically connected to the hard disks 151a˜151n, the fans 152, the power detector 153, the fan speed detector 154, and the temperature sensor 155.

In the instant embodiment, the hard disks 151a˜151n are Serial-attached Small Computer System Interface (SAS) disks, respectively. The RAID storage device 15 utilizes the Just a Bunch of Disk (JBOD) technology to combine the plurality of hard disks 151a˜151n into a large logical storage space such that the operating system of the server 11 sequentially stores data in the hard disks 151a˜151n.

The fans 152 is configured for lowering the operating temperature being operatively generated by each of the hard disks 151a˜151n to prevent the hard disks 151a˜151n from overheat. When the internal temperature of the RAID storage device 15 increases while the hard disks 151a˜151n operate, the rotational speed of at least one of the fans 152 is correspondingly increased. When the operating frequency (i.e., accessing frequency) of the hard disks 151a˜151n drop, the rotational speed of at least one of the fans 152 is correspondingly reduced to conserve power.

In practice, the fans 152 can be disposed near the hard disks 151a˜151n for efficiently lowering or eliminating the heat being generated by the hard disks 151a˜151n. The exact number and actual positions of the fans 152 may be configured depend upon the practical operation needs, the size of space available, and cooling requirements of the RAID storage device 15 and the instant embodiment is not limited thereto.

The power detector 153 is configured for operatively detecting the power consumption of the RAID storage device 15 while the RAID storage device 15 operates. The power consumption of the RAID storage device is mainly consumed by the hard disks 151a˜151n, the fans 152, and the expander control unit 156. The power detector 153 operatively transmits the power consumption information to the expander control unit 156. In one embodiment, the power detector 153 can be integrated with the power port of the RAID storage device 15 and the power detector 153 can calculate the power consumption of the RAID storage device 15 by detecting the supplying current and supplying voltage being supplied by the power supply 13 to the RAID storage device 15.

The fan speed detector 154 is configured for operatively detecting the rotational speeds of the fans 152 and generating a rotational speed signal. The rotational speed signal is transmitted to the expander control unit 156. The fan speed detector 154 can obtain the rotational speeds of the fans 152 by detecting the rotational speed of the motors of the fans 152 or the voltage level of the control signal outputted by the expander control unit 156 for driving the fans 152. The temperature sensor 155 is configured for sensing the operating temperature of the RAID storage device 15 and outputting a temperature signal to the expander control unit 156.

The expander control unit 156 performs the data transfer operations (i.e., the data accessing operations of the hard disks 151a˜151n) with the hard disks 151a˜151n through a second transmission interface (not shown). The second transmission interface are configured base on the transmission interface of the hard disks 151a˜151n. In the instant embodiment, the second transmission is a Serial-attached Small Computer System Interface and the expander control 156 is connected to the hard disks 151a˜151n through the Serial-attached Small Computer System Interface for performing data accessing operations. In practice, the second transmission interface may be implemented by a Serial advanced Technology Attachment (SATA), however the instant embodiment is not limited thereto.

The expander control unit 156 can further adjust the rotational speeds of the fans 152 according to the temperature signal outputted by the temperature sensor 155 for maintaining the operating temperature of the RAID storage device 15 at a predetermined temperature threshold. Such that, the damages of the hard disks 151a˜151n due to overheat can be avoided. The expander control unit 156 operatively controls the operations of the fans 152 according to the rotational speed signal outputted by the fan speed detector 154.

The expander control unit 156 has a power control application (not shown). The power control application generates an operation interface which enables a user of the RAID storage device 15 to configure a system power limit and an upper power consumption limit of the RAID storage device 15, wherein the user configures the system power limit and the upper power consumption limit of the RAID storage device 15 according to the total supplying power supplied by the power supply 13 of the server system 1.

Briefly, the expander control unit 156 operatively executes a power management procedure according to the upper power consumption limit configured so that the overall power consumption of the RAID storage device is lower than the upper power consumption limit. Specifically, the expander control unit 156 determines whether the power consumption of the RAID storage device 15 exceeds the upper power consumption limit according to the power consumption information outputted from the power detector 153. When the power consumption of the RAID storage device 15 detected exceeds the upper power consumption limit (e.g., when the RAID storage device 15 operates at high operating frequency), the expander control unit 156 executes the power management procedure to reduce the power consumption of the RAID storage device 15.

The power management method includes the following steps. The expander control unit 156 causes the power detector 153 to detect the power consumption of the RAID storage device 15. The expander control unit 156 operatively determines whether the power consumption of the RAID storage device 15 exceeds the upper power consumption limit. When the power consumption of the RAID storage device 15 detected has exceeded the upper power consumption limit, the expander control 156 unit executes a plurality of power-saving procedures until the power consumption of the RAID storage device 15 becomes lower than the upper power consumption limit.

The power-saving procedures include the following steps. The expander control unit 156 first detects the operating frequency of the expander control unit 156 (i.e., detect the switching operations among the hard disks). The expander control unit 156 reduces the operating frequency of the expander control unit 156 and causes the expander control unit 156 to enter a low-frequency operating mode.

Next, the expander control unit 156 detects and turns off a portion of connections on the first transmission interface (e.g., SAS interface) between the RAID storage device 15 and the server 11. For instance, turns off unnecessary connections on the first transmission interface at present so as to reduce the data transfer rate between the RAID storage device 15 and the server 11.

Then, the expander control unit 156 reduces the rotational speeds of the fans 152 and causes the fans 152 to enter a low-speed operating mode. In the instant embodiment, the rotational speeds of the fans 152 in the low-speed operating mode is configured based on the minimum rotational speeds of the fans 152 needed to ensure the operational stability of the RAID storage device 15. In the instant embodiment, the expander control unit controls the rotational speeds of the fans 152 according to an upper ambient temperature limit (e.g., 60° C.) which is the maximum operating temperature that the RAID storage device 15 can stably operate without overheating. In other words, when the fans 152 operates in the low-speed operating mode, the fans 152 can operatively maintain the ambient temperature of the RAID storage device 15 at or below 60° C. so that the operational of the RAID storage device 15 is not affected.

The expander control unit 156 further reduces the spin rates of the hard disks 151a˜151n (i.e., reduces the access frequency of the hard disk 151a˜151n) and causes the hard disks 151a˜151n to enter a low-speed operating state so as to reduce the power consumption of the hard disks 151a˜151n.

The expander control unit 156 controls the hard disk 151a˜151n based on the access frequency associated with each of the hard disks 151a˜151n such that the hard disk with the lowest access frequency among all the hard disks to enters a standby state or a hibernation state. In the instant embodiment, the expander control unit 156 can determine the access frequency associated with each of the hard disks 151a˜151n according to the number of accessing times accumulated for each of the hard disks 151a˜151n or by analyzing the status signals outputted by each of the hard disks 151a˜151n. The expander control unit 156 generates an access list containing the hard disks 151a˜151n in sequence from the lowest access frequency to the highest access frequency and sequentially drives the hard disk 151a˜151n to enter the standby state or the hibernation state according to the to the access list.

It is worth to note that the power management method further includes a plurality of efficiency-enhancing procedures. The efficiency-enhancing procedures are used for enhancing the performance of the RAID storage device 15. More specifically, the expander control unit 156 executes the efficiency-enhancing procedures sequentially upon detected that the power consumption of the RAID storage device 15 is lower than a lower power consumption limit so as to enhance the performance of the RAID storage device 15. The efficiency-enhancing procedures include the following steps.

The expander control unit 156 detects whether at least one of the hard disks 151a˜151n operates in the standby mode or in the hibernation mode, and the expander control unit 156 wakes up all of the hard disks 151a˜151n operated in the standby mode or in the hibernation mode.

The expander control unit 156 then determines whether at least one of the hard disks 151a˜151n is operating in the low-speed operating state according to the spin rate of each of the hard disks 151a˜151n detected. The expander control unit 156 increases the spin rate of the hard disks 151a˜151n being operated in the low-speed operating state to a normal spin rate to improve the access efficiency of the hard disks 151a˜151n.

Next, the expander control unit 156 determines whether the fans 152 are operating in the low-speed operating mode. For example, the expander control unit 156 can control the fan speed detector 154 to detect the rotational speeds of the fans 152. When the expander control unit 156 determines that the fans 152 are operating in the low-speed operating mode, the expander control unit 156 gradually increases the rotational speeds of the fans 152 and causes the fans 152 to leave the low-speed operating mode. More specifically, the expander control unit 156 adjusts the rotational speeds of the fans 152 to the lowest rotational speeds possible for the RAID storage device 15 to have optimal performance. In the instant embodiment, the expander control unit 15 configures the rotational speeds of the fans 152 according to an upper ambient temperature limit (e.g., 55° C.) for the RAID storage device 15 to have optimal performance. In other words, the expander control unit 156 gradually increases the rotational speeds of the fans 152 to maintain the upper ambient temperature limit of the RAID storage device 15 at or below than 55° C. Such that, the RAID storage device 15 can operate at optimal performance without wasting the power supplied thereto.

The expander control unit 156 determines whether a portion of connections on the first transmission interface (e.g., SAS interface) connecting the RAID storage device 15 and the server 11 has been turned off according to data transmission state of the first transmission interface. When the expander control unit 156 determines that a portion of connections on the first transmission interface has been turned off, the expander control unit 156 turns on the portion of connections of the first transmission interface being turned off to improve the data transfer rate between the RAID storage device 15 and the server 11. Thereby, increase the performance of the RAID storage.

Moreover, the expander control unit 156 determines whether the expander control unit 156 operates in the low-frequency operating mode. When the expander control unit 156 is detected to be operated in the low-frequency operating mode, the expander control unit 156 restores the operating frequency of the expander control unit 156 to the normal operating frequency thereof.

When the expander control unit 156 determines that the power consumption of the RAID storage device 15 has exceeded the upper power consumption limit during the execution of the efficiency-enhancing procedures, the expander control unit 156 stops executing the efficiency-enhancing procedures so as to prevent the power consumption of the RAID storage device 15 from exceeding the upper power consumption limit.

It is worth to note that the user of the server system 1 can configure the system power limit of the RAID storage device 15 according to the total supplying power supplied from the power supply 13, the average power consumption of the RAID storage device 15 of the server system 1, or the maximum power consumption of the hard disks 151a˜151n of the RAID storage device 15. In another embodiment, the user of the server 11 can also configure the system power limit of the RAID storage device 15 according to the operation mode of the RAID storage device 15 (e.g., data access and storage or backup storage). The user of the server 11 can configure the upper power consumption limit according to the system power limit, wherein the upper power consumption is lower than the system power limit of the RAID storage device 15.

For example, the user of the server system 1 can configure the upper power consumption limit according to the system power limit (such as 80% or 90% of the system power limit). Such that when the RAID storage device 15 is in operation, the power consumption of the RAID storage device 15 does not exceed the system power limit of the RAID storage device 15.

Additionally, the user may configure the lower power consumption limit of the server system 1 according to the minimum power consumption limit of the RAID storage device 15 in the server system 1. The user can configure the lower power consumption limit through the operation interface provided by a power control application of the expander control unit 156 or the server 11.

In other words, the user of the server system 1 can configure the system power limit, the upper power consumption limit, and the lower power consumption limit of the RAID storage device 15 according to the practical structure and operational requirements of the RAID storage device 15.

More specifically, in the instant embodiment, the user configure the system power limit, the upper power consumption limit, and the lower power consumption limit of the RAID storage device 15 through the operation interface provided by a power control application of the expander control unit 156. In another embodiment, the user may configure the upper power consumption limit and the lower power consumption limit of the RAID storage device 15 through the server 11. For example, the operating system of the server 11 has the application installed therein and the application provides interface upon execution which enables the user of the server system 1 configuring the upper power consumption limit. The server 11 transmits the upper power consumption limit configured to the RAID storage device 15 through the first transmission interface.

More specifically, the expander control unit 156 includes an integrator circuit 1561 and a SAS expander 1563. The integrator circuit 1561 is electrically connected to the SAS expander 1563 and the hard disks 151a˜151n. The SAS expander 1563 is electrically connected to the hard disks 151a˜151n, the fans 152, the power detector 153, the fan speed detector 154, and the temperature sensor 155, respectively.

The integrator circuit 1561 is configured for performing integration computations to an accessing signal received from each of the hard disks 151a˜151n through the second transmission interface. The integrator circuit 1561 further outputs a frequency signal which corresponds to the access frequency associated with each of the hard disks 151a˜151n. Taking the hard disks 151a˜151n uses SAS interface to connect the expander control unit 156 as an example, the integrator circuit 1561 can perform integration operations on the access frequency of the hard disks 151a˜151n according to the accessing signal received from the 11th pin (i.e., ready LED pin) on the SAS interface of each of the hard disks 151a˜151n.

The SAS expander 1563 is configured for controlling the data transfer between the server 11 and the hard disks 151a˜151n. When the SAS expander 1563 receives the data through the first transmission interface between the server 11 and the hard disks 151a˜151n, the SAS expander 1563 utilizes the JBOD technology and sequentially switch the hard disks 151a˜151n for performing the data access operation between the server 11 and the hard disks 151a˜151n according to a partition table.

In addition, the SAS expander 1563 can also be configured for executing the aforementioned power management procedure. While the RAID storage device 15 is in operation, the SAS expander 1563 determines whether the power consumption of the RAID storage device 15 exceeds the upper power consumption limit and executes the power-saving procedures and the efficiency-enhancing procedures, accordingly. During the execution of power management procedure, the SAS expander 1563 determines the access frequency of each of the hard disks 151a˜151n according to the frequency signal outputted from the integrator circuit 1561. The SAS expander 1563 may generate the accessing list containing the hard disks 151a˜151n in sequence from the lowest access frequency to the highest access frequency by comparing the accessing frequency of the hard disks 15a˜151n. The SAS expander 1563 sequentially controls the hard disk 151a˜151n to enter the standby state or the hibernation state based on the accessing list to reduce the power consumption of the RAID storage device 15.

It is worth to note that the integrator circuit 1561 may be implemented by an integrating circuit comprising of an operational amplifier, a resistance, and a capacitance. The integrator circuit 1561 can be implemented by the SAS expander 1563. For example, the SAS expander 1563 may be electrically connected to the ready LED pin of each of the hard disks 151a˜151n through the second transmission interface. Such that the SAS expander 1563 can determine the access frequency of each of the hard disks 151a˜151n by computing the duty cycle of the ready LED pin.

The SAS expander 1563 may be implemented by a processing chip such as a microcontroller or an embedded controller. The processing chip can be programmed with the code for the power control application through firmware design. The processing chip can be disposed on the SAS expander card and configured to connect the hard disks 151a˜151n and the server 11.

In the instant embodiment, the RAID storage device 15 utilizes the JBOD technology to combine the hard disks 151a˜151n into a large RAID storage disk. However, in another embodiment, the RAID storage device 15 may utilize other type of RAID technology, such as the Redundant Array of Independent Disks 0˜7 (RAID 0˜7) technology, to combine the hard disks 151a˜151n into a large RAID storage disk and the instant embodiment is not limited to the example described herein. In addition, the number of the RAD storage devices and servers installed in the server system 1 can be configured according to the operational requirements as well as the storage capacity requirements. It shall be note that FIG. 1 is merely used to show an implementation and operation of the RAID storage device 15 and the present disclosure is not limited thereto. The present disclosure does not limit the actual structure of the server system 1 or the exact type, exact structure, implementation method, and/or type of connection associated with the server 11, the power supply 13 and the RAID storage device 15.

It is worth to note that the power management technology of the RAID storage device 15 disclosed in the present disclosure is different from the general power-saving techniques adopted by the computer system and electronic storage device. The conventional power-saving technology detects the overall operating frequency of the computer system and/or the electronic storage device and causes the computer system and/or electronic the storage device to enter a power saving mode when detected that the computer system and electronic storage device has been idled or has not been operated by the user for a predetermined time so as to conserve power. In other words, the conventional power-saving technology drives the computer system and/or the electronic storage device to enter a power saving mode upon detected that the operational frequency of the computer system and/or the electronic storage device is too low.

On the other hand, the spirit of the present disclosure is that the power-saving mode is only activated when the overall power consumption of the RAID storage device 15 exceeds the upper power consumption limit (i.e., the operating frequency of RAID storage device 15 is increasingly high) configured so as to lower the power consumption of the RAID storage device 15, wherein the upper power consumption limit is configured by the user of the server system 1 based on the system power limit assigned.

Moreover, when the overall power consumption of the RAID storage device 15 is detected to be lower than the lower power consumption limit, the RAID storage device 15 initiates the efficiency-enhancing procedures to enhance the performance of the RAID storage device 15. Under the structure of the server system 1 described in the present disclosure, the user of the server system 1 can dynamically configure the operating mode of the RAID storage device 15 and the supplying power supplied thereto by configuring the upper and the lower power consumption limits of the RAID storage device 15.

Therefore, under same amount of power supplied not only the supplying power of the server system 1 can stably support the operation of the RAID storage device 15, but also the RAID storage device 15 can employ more number of hard disk in comparison to the conventional the server system. The operating mode of the RAID storage device 15 can be configured through configuring the upper and the lower power consumption limits of the RAID storage device 15, thereby increase the applicability of the RAID storage device 15.

The power management function of the RAID storage device 15 in the present disclosure is built in the RAID storage device 15, and does not have to accommodate the operation of the server 11. Hence does not increase the computational burden on the server 11 at same time, the RAID storage device 15 can be compatible to all types of server thereby enhance the applicability of the RAID storage device 15.

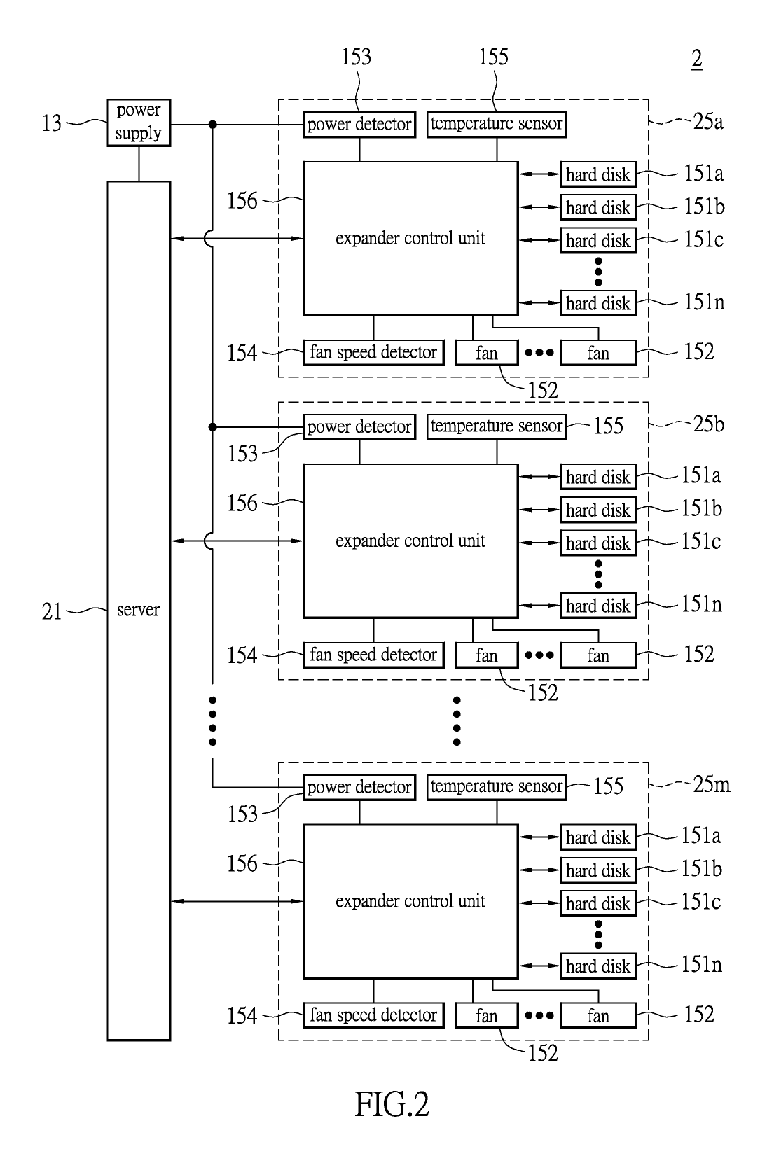

As previously described, the server system can further include a plurality of the RAID storage devices so as to expand the data storage capacity of the server system. Each of the RAID storage devices can be configured with a respective upper power consumption limit and the respective operation mode. Please refer to FIG. 2, which shows a block diagram illustrating a server system provided in accordance to a second exemplary embodiment of the present disclosure.

The difference between the server system 2 of FIG. 2 and the server system 1 of FIG. 1 is in the system structure of the server system 2. The server system 2 includes a server 21, a power supply 13, and a plurality of the RAID storage devices 25a˜25m. The server 21 is electrically connected to the RAID storage devices 25a˜25m. The power supply 13 is respectively electrically connected to the RAID storage devices 25a˜25m and the server 21 to supply necessary operating power to the RAID storage devices 25a˜25m and the server 21. In the instant embodiment, each of the RAID storage devices 25a˜25m configures a corresponding upper power consumption limit and a corresponding lower power consumption limit according to the system power limit assigned for each of the RAID storage devices 25a˜25m so as to limit the power consumption of the each of the RAID storage devices 25a˜25m.

In the instant embodiment, the hard disks 151a˜151n in the RAID storage devices 25a˜25m are SAS disks. The server 21 connects the RAID storage devices 25a˜25m through SAS interface to perform data storage operation.

Briefly, a user of the server system 2 can configure the system power limit according to the operational requirements and power requirement. More specifically, the user of the server system 2 can actively configure the system power limit for each of the RAID storage devices 25a˜25m according to the supplying power supplied by the power supply 13 and the storage application of the RAID storage devices 25a˜25m. The user of the server system 2 can configure the upper power consumption limit and the lower power consumption limit for each of the RAID storage devices 25a˜25m according to the system power limit assigned for each of the RAID storage devices 25a˜25m.

In addition, the user of the server system 2 can configure the system power limit and the upper and lower power consumption limit for each of the RAID storage devices 25a˜25m through the operation interface provided by the power control application of the expander control unit 156. The user of the server system 2 can also configure the power consumption of each of the RAID storage devices 25a˜25m through the interface provided by the server 11.

For example, when the power supply 13 can only supply at maximum 10000 W. The system power limit for each of the RAID storage device 25a˜25m may be evenly allocated based on the maximum supplying power (i.e., 10000 W) by the user. The user of the server system 2 configures the upper and the lower power consumption limits for each RAID storage devices 25a˜25m according to the system power limit of each respective the RAID storage devices 25a˜25m. Such that the power consumption of each RAID storage devices 25a˜25m is ensured not to exceed the system power limit. The performances of each RAID storage devices 25a˜25m can be controlled by configuring the lower power consumption limit of each RAID storage devices 25a˜25m. The user of the server system 2 can respectively configure the operating modes of the RAID storage devices 25a˜25m according to the upper power consumption limit associated with each RAID storage devices 25a˜25m so that the RAID storage devices 25a˜25m can stably operate under the power allocated.

For another example, supposing the server system 21 includes the RAID storage devices 25a˜25f, wherein the RAID storage devices 25a˜25d are configured for data storage while the RAID storage devices 25e and 25f are configured for backup storage. The operating frequency of the RAID storage devices 25a˜25d are higher than the operating frequency of the RAID storage devices 25e and 25f in full operational state, hence the power consumption of the RAID storage devices 25a˜25d are also higher than the power consumption the RAID storage devices 25e and 25f. The user of the server system 21 may allocated the supplying power from the power supply 13 for the RAID storage devices 25a˜25f according to the operating mode of the RAID storage devices 25a˜25d. Particularly, the user may allocate 80% of the supplying power supplied by the power supply 13 to the RAID storage devices 25a˜25d by configuring the system power limit of the RAID storage devices 25a˜25d, and allocate 20% of the power supplied by the power supply 13 to the RAID storage devices 25e and 25f by configuring the system power limit of the RAID storage devices 25e and 25f. The user can further configure the upper and lower power consumption limit of the RAID storage devices 25a˜25d according to the system power limit of the RAID storage devices 25a˜25d, such that the supplying power from the power supply 13 can be efficiently distributed and the power consumption the RAID storage devices 25a˜25d can be maintained under each receptive system power limit.

The expander control unit 156 of each RAID storage devices 25a˜25m can each execute the power-saving procedures of the power management procedure according to the respective upper power consumption limit so that the power consumption of each RAID storage device 25a˜25m is lower than the respective upper power consumption limit. More specifically, the expander control unit 156 of each RAID storage devices 25a˜25m can actively detect the power consumption of the respective RAID storage device in operation and configures the operating mode of the hard disks 151a˜151n, the fans 152, and the expander control unit 156 of the corresponding RAID storage device, so that the power consumption of each RAID storage devices 25a˜25m is lower than the respective upper power consumption limit. Similarly, the expander control unit 156 of each RAID storage devices 25a˜25m can execute the power-saving procedures of the power management procedure according to the respective upper power consumption limit to enhance the performance of each RAID storage device 25a˜25m.

When any one of RAID storage device 25a˜25m (e.g., RAID storage device 25a) detects that the power consumption of the RAID storage device (e.g., RAID storage device 25a) exceeds the respective upper power consumption limit, the RAID storage device (e.g., RAID storage device 25a) sequentially executes the plurality of power-saving procedures until the power consumption of the RAID storage device (e.g., RAID storage device 25a) is lower than the respective upper power consumption limit. When the RAID storage device (e.g., RAID storage device 25a) detects that the power consumption of the RAID storage device (e.g., RAID storage device 25a) drops below the respective lower power consumption limit, the RAID storage device (e.g., RAID storage device 25a) executes the plurality of efficiency-enhancing procedures to enhance the performance of the RAID storage device (e.g., RAID storage device 25a). During the execution of the efficiency-enhancing procedures, when detected that the power consumption of the RAID storage device (e.g., RAID storage device 25a) exceeds the upper power consumption limit, the RAID storage device (e.g., RAID storage device 25a) stops executing the efficiency-enhancing procedures.

The overall structure of each RAID storage device 25a˜25m is essentially the same as the RAID storage device 15 of the FIG. 1. Those skilled in the art should be able to infer the operation associated with each RAID storage device 25a˜25m, and further descriptions are hereby omitted.

In compare to conventional server system which supplies power based on the maximum power consumed by each RAID storage device is for ensure the RAID storage device can stably operate. On the contrary, the server system 2 can dynamically configure the operating mode of each RAID storage device 25a˜25m by configuring the respective system power limit and the respective upper power consumption limit, so that the supplying power supplied from power supply 13 can be fully and efficiently utilized, thereby avoid unnecessary waste of supplying power. When the user of the server system 2 needs to expand the data storage capacity by employing more number of RAID storage device 25a˜25m, the user can through dynamically configure the system power limit of RAID storage device 25a˜25m and ensure all of the RAID storage device 25a˜25m in the server system 2 can be stably operated.

In the instant embodiment, only one power supply is used in the server system 2 to power the server 21 and the RAID storage device 25a˜25m. However, in practice, in order to prevent the RAID storage device 25a˜25m from sudden system shut-down or stop functioning due to the malfunction of the power supplied, the server system 2 can includes a plurality of power supplies for powering each of the RAID storage device 25a˜25m individually so as to prevent the possibility of data corruption in the RAID storage device 25a˜25m due to unexpected system shut-down.

It shall be noted that FIG. 2 is merely used to illustrate an implementation of the server system 2 of and the instant embodiment is not limited thereto. The present disclosure does not limit the exact structure of the server system 2. More specifically, The present disclosure does not limit the exact structure, the exact implementation method, operation method and/or the type of connection associated with the server 21, the power supply 13 and RAID storage device 25a˜25m.

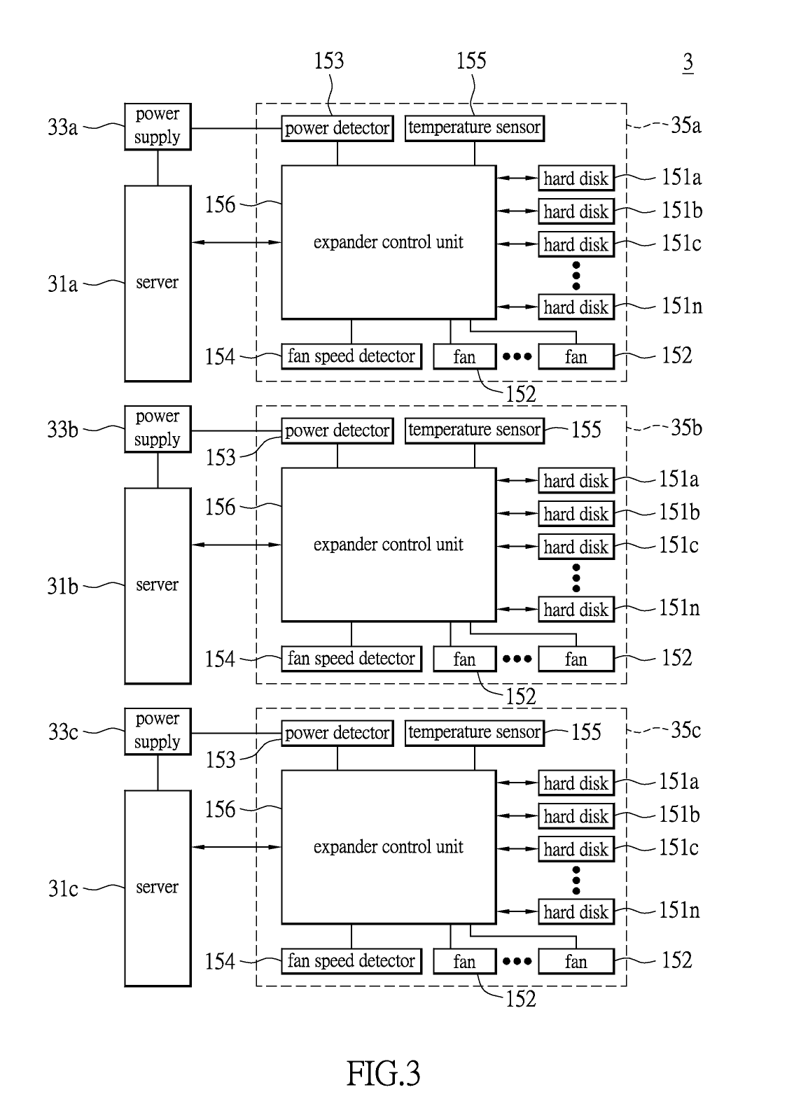

The aforementioned server system has one server connected to multiple RAID storage devices. In practice, the server system may include a plurality of servers and a plurality of RAID storage devices, wherein each server is configured for controlling the RAID storage device connected thereto. Please refer to FIG. 3, which shows a block diagram illustrating a server system provided in accordance to a third exemplary embodiment of the present disclosure.

The difference between the server system 3 of FIG. 3 and the server system 1 of FIG. 1 is the system structure of the server system 3. The server system 3 includes a plurality of servers 31a˜31c, a plurality of power supplies 33a˜33c, and a plurality of RAID storage devices 35a˜35c.

In the instant embodiment, the servers 31a˜31c in the server system 3 are electrically connected to the RAID storage devices 35a˜35c for performing the data transfer operations. The power supply 33a is electrically connected to the server 31a and the RAID storage devices 35a for supplying the necessary operating power to the server 31a and the RAID storage devices 35a. The power supply 33b is electrically connected to the server 31b and the RAID storage devices 35b for supplying the necessary operating power to the server 31b and the RAID storage devices 35b. The power supply 33c is electrically connected to the server 31c and the RAID storage devices 35c for supplying the necessary operating power to the server 31c and the RAID storage devices 35c.

Briefly, the servers 31a˜31c in the server system 3 can each access data from the hard disks 151a˜151n of the RAID storage devices 35a˜35c. The user of the server system 3 can configure the system power limit and the upper power consumption limit for each of the RAID storage devices 35a˜35c. While the RAID storage devices 35a˜35c operates, the RAID storage devices 35a˜35c sequentially execute the plurality of power-saving procedures so that the power consumption of the RAID storage devices 35a˜35c is lower than the respective upper power consumption limit configured. Thus, the total power consumption of the RAID storage devices 35a˜35c can be prevented from exceeding the respective system power limit of the RAID storage devices 35a˜35c. Accordingly, the RAID storage devices 35a˜35c can be stably operated under the power supplied from the power supplies 33a˜33c.

The rest of structure and the operation associated with the RAID storage devices 35a˜35c is essentially the same as the RAID storage devices 15 of the FIG. 1. Based on the above explanation, those skilled in the art should be able to infer the operation associated with the RAID storage devices 35a˜35c and further descriptions are hereby omitted.

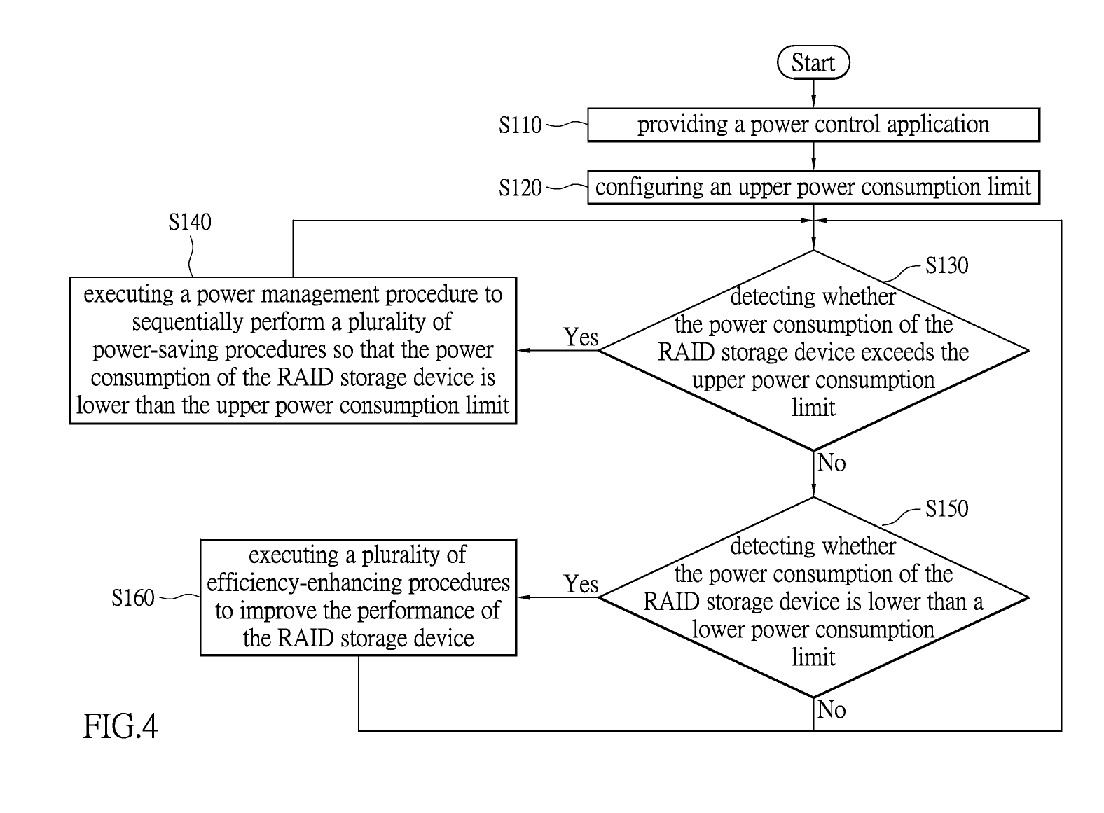

From the aforementioned embodiments, the present disclosure may generalize a power management method for the aforementioned RAID storage devices. The power management method can be implemented by writing the corresponding firmware into the expander control unit. Please refer to FIG. 4 in conjunction with FIG. 1. FIG. 4 shows a flowchart diagram illustrating a power management method of a RAID storage device provided in accordance to a fourth exemplary embodiment of the present disclosure.

In Step S110, the expander control unit 156 of the RAID storage devices 15 provides a power control application. The power control application generates an operation interface upon execution for the user of the RAID storage device 15 to operate. In Step S120, the user of the RAID storage device 15 configures a system power limit and an upper power consumption limit of the RAID storage device 15. In Step S130, the expander control unit 156 detects whether the power consumption of the RAID storage device 15 exceeds the upper power consumption limit.

The expander control unit 156 can control the power detector 153 to detect the power consumption of the RAID storage device 15. The expander control unit 156 determines whether the power consumption of the RAID storage device 15 exceeds the upper power consumption limit based on the detection result.

When the expander control unit 156 determines that the power consumption of the RAID storage device 15 exceeds the upper power consumption limit, the expander control unit 156 executes Step S140. Conversely, when the expander control unit 156 determines that the power consumption of the RAID storage device 15 is lower than the upper power consumption limit, the expander control unit 156 executes Step S150.

In Step S140, the expander control unit 156 executes a power management procedure to sequentially execute a plurality of power-saving procedures such that the power consumption of the RAID storage device 15 is lower than the upper power consumption limit. The expander control unit 156 returns to Step S130 after complete the execution of the power management procedure.

In Step S150, the expander control unit 156 detects whether the power consumption of the RAID storage device 15 is lower than the lower power consumption limit.

When the expander control unit 156 determines that the power consumption of the RAID storage device 15 is lower than the lower power consumption limit, the expander control unit 156 executes Step S160. Conversely, when the expander control unit 156 determines that the power consumption of the RAID storage device 15 exceeds the upper power consumption limit, the expander control unit 156 returns to Step S130. In Step S160, the expander control unit 156 sequentially executes the efficiency-enhancing procedures to enhance the performance of the RAID storage device 15.

After executing a power-saving procedures, such as reducing the operating frequency, turning off the connecting transmission, reducing the access frequency of the hard disks, reducing the rotational speeds of the fans, and causing the hard disks to enter a standby state or a hibernation state, the expander control unit 156 operatively determines whether the power consumption of the RAID storage device 15 still exceeds the upper power consumption limit. When the expander control unit 156 determines that the RAID storage device 15 is lower than or equal to the lower power consumption limit, the expander control unit 156 stops executing the power-saving procedures.

According to the aforementioned embodiments, the user of the server system 1 can configure the system power limit according to the total power supplied from the power supply 13, the average power consumption of the RAID storage device 15, the maximum power consumption of the hard disks 151a˜151n in the server system 1, or the operation mode of the RAID storage device 15. The user of the server system 1 can configure the upper power consumption limit according to the system power limit configured. The user of the server system 1 can configure the lower power consumption limit based on the minimum power consumption of the hard disks 151a˜151n. In addition, the upper and the lower power consumption limits can be configured by the of the server system 1 through the operation interface provided by the power control application of the expander control unit 156 or the server 11.

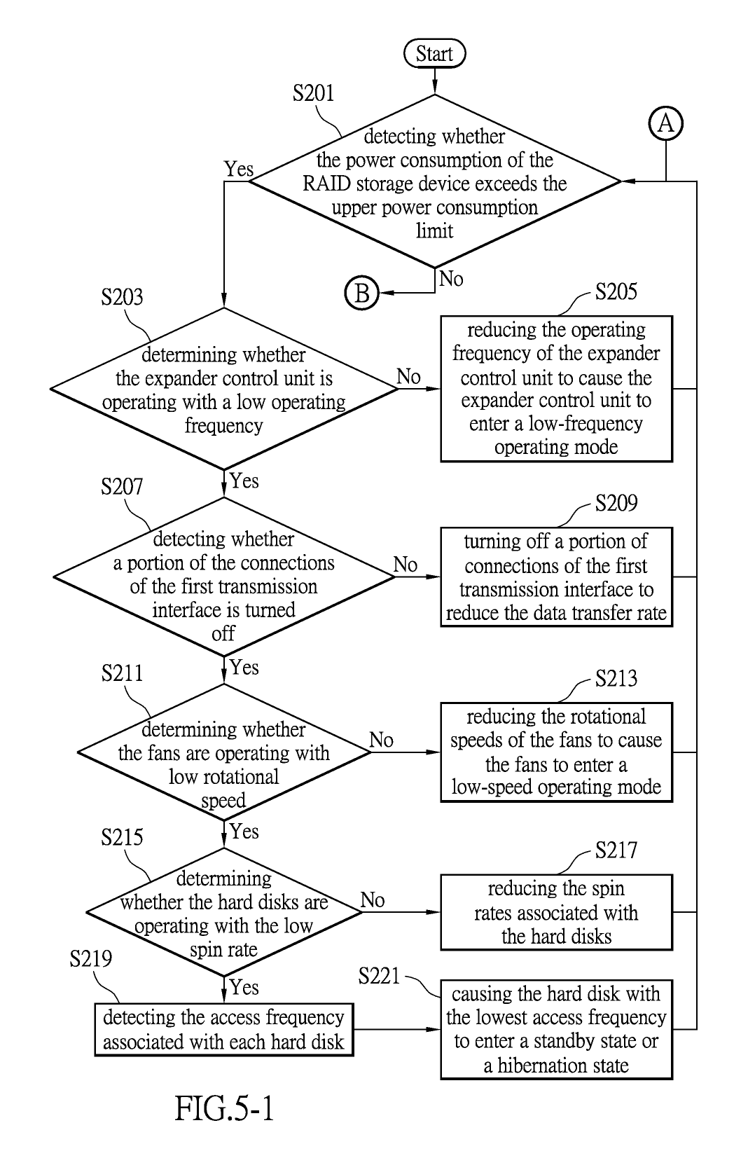

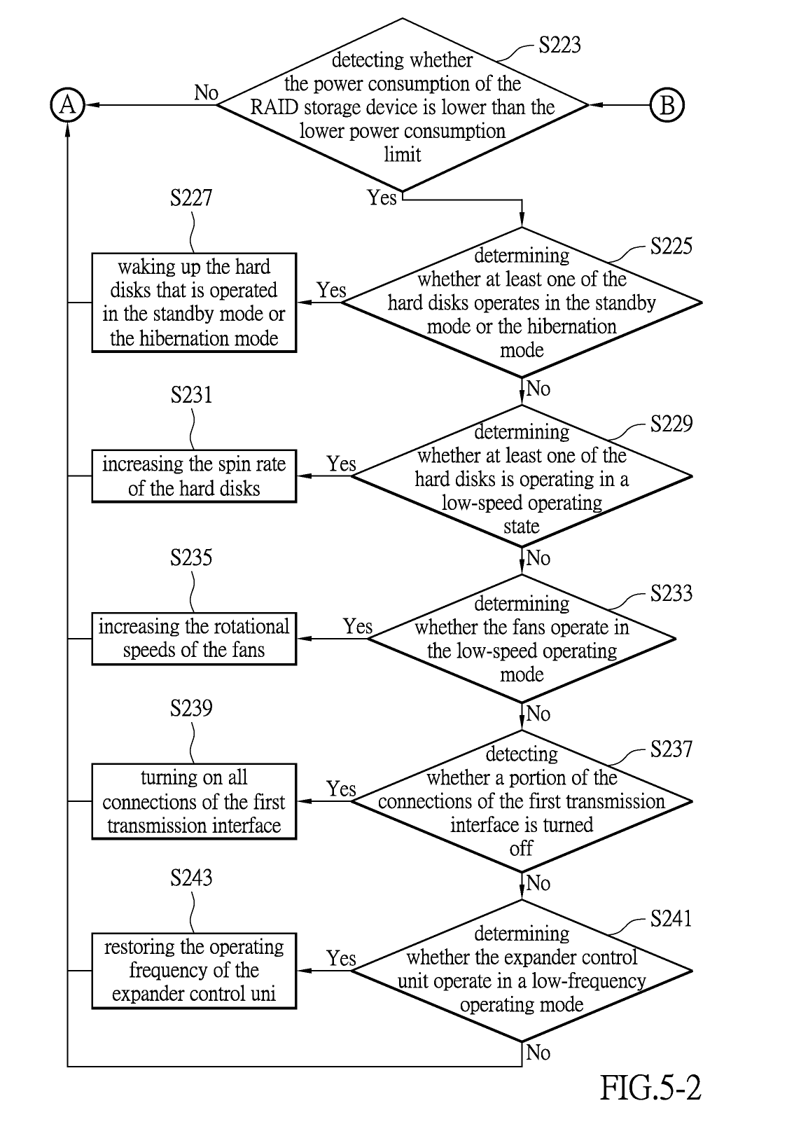

Details regarding the power-saving procedures in the power management procedure and the execution of efficiency-enhancing procedures are further provided in the following description. Please refer to FIG. 5-1 and FIG. 5-2 in conjunction with FIG. 1, wherein FIG. 5-1 and FIG. 5-2 are flowchart diagrams respectively illustrating a power management procedure of the power management method provided in accordance to the fourth exemplary embodiment of the present disclosure.

In Step S201, while the RAID storage device 15 is in operation, the expander control unit 156 detects whether the power consumption of the RAID storage device 15 exceeds the upper power consumption limit with the power detector 153.

When the expander control unit 156 determines that the power consumption of the RAID storage device 15 exceeds the upper power consumption limit, the expander control unit 156 executes Step S201. Conversely, when the expander control unit 156 determines that the power consumption of the RAID storage device 15 is lower than the lower power consumption limit, the expander control unit 156 executes Step S203.

In Step S201, the expander control unit 156 determines whether the expander control unit operates with a low operating frequency (e.g., the switching frequency associated with the data transfer operation between the server 11 and the hard disks 151a˜151n).

When the expander control unit 156 determines that operating frequency thereof is at the low operating frequency, the expander control unit 156 executes Step S207. Conversely, when the expander control unit 156 determines that the operating frequency thereof is not at the low operating frequency, the expander control unit 156 executes Step S205. In Step S205, the expander control unit 156 reduces the operating frequency of the expander control unit 156 and cause the expander control unit 156 to enter a low-frequency operating mode so as to reduce the power consumption of the expander control unit 156. After that, the expander control unit 156 returns to Step S201 to determine whether the power consumption of the RAID storage device 15 still exceeds the upper power consumption limit.

In Step S207, the expander control unit 156 detects whether a portion of the connections of the first transmission interface is turned off according to the data transmission state of the first transmission interface between the expander control unit 156 and the server 11.

When the portion of the connections of the first transmission interface is turned off, the expander control unit 156 executes Step S211. Conversely, when the portion of the connections of the first transmission interface is not turned off, the expander control unit 156 executes Step S209. In Step S209, the expander control unit 156 turns off the portion of connections of the first transmission interface (e.g., unused connections) to reduce the data transfer rate between the expander control unit 156 and the server 11 and returns to the Step S201.

In Step S211, the expander control unit 156 determines whether the fans 152 are operating with low rotational speed using the fan speed detector 154, i.e., the expander control unit 156 determines whether the fans 152 are operating in a low-speed operating mode.

When the expander control unit 156 determines that the rotational speeds of the fans 152 are at low rotational speed the expander control unit 156 executes Step S215. Conversely, when the expander control unit 156 determines that the rotational speeds of the fans 152 are not at the low rotational speed, the expander control unit 156 executes Step S213.

In Step S213, the expander control unit 156 reduces the rotational speeds of the fans 152 to cause the fans to enter a low-speed operating mode and returns to Step S201.

In Step S215, the expander control unit 156 determines whether the hard disks operate with the low spin rate. When the expander control unit 156 determines that the hard disks 151a˜151n operate with the low spin rate, the expander control unit 156 executes Step S219. Conversely, when the expander control unit 156 determines that the hard disks 151a˜151n does not operate with the low spin rate, the expander control unit 156 executes Step S217. In the step S217, the expander control unit 156 reduces the spin rates associated with the hard disks 151a˜151n and cause the hard disks 151a˜151n to operate in a low-speed operating state to further reduce the power consumption of the hard disks 151a˜151n. The expander control unit 156 returns to step S201 afterward.

In Step S219, the expander control unit 156 detects the access frequency associated with each of the hard disk 151a˜151n. The expander control unit 156 may determine the access frequency associated with each hard disk 151a˜151n based on the accessing times of the hard disks 151a˜151n or the accessing signal received from the 11th pin on SAS interface to detect the access frequency associated with each hard disk 151a˜151n.

In Step S221, the expander control unit 156 causes the hard disk 151a˜151n among all the hard disks with the lowest access frequency to enter a standby state or a hibernation state to further reduce the power consumption of the hard disk 151a˜151n.

In Step S223, the expander control unit 156 detects whether the power consumption of the RAID storage device 15 is lower than the lower power consumption limit with the power detector 153.

When the expander control unit 156 determines that the power consumption of the RAID storage device 15 is lower than the lower power consumption limit, the expander control unit 156 executes Step S225. Conversely, when the expander control unit 156 determines that the power consumption of the RAID storage device 15 exceeds the lower power consumption limit, the expander control unit 156 returns to Step S201.

In Step S225, the expander control unit 156 determines whether at least one of the hard disks 151a˜151n operates in the standby mode or the hibernation mode through detecting the operating state of the hard disks 151a˜151n.

When the expander control unit 156 determines that at least one of the hard disks 151a˜151n operates in the standby mode or the hibernation mode, the expander control unit 156 executes Step S227. Conversely, when the expander control unit 156 determines that all the hard disks 151a˜151n operate in the normal operating mode, the expander control unit 156 executes Step S229. In Step S227, the expander control unit 156 wakes up the hard disks 151a˜151n being operated in the standby mode or the hibernation mode and returns to step S201.

In Step S229, the expander control unit 156 determines whether at least one of the hard disks 151a˜151n operates in the low-speed operating state according to the spin rates of the hard disks 151a˜151n. When the expander control unit 156 determines that at least one of the hard disks 151a˜151n operates in the low-speed operating state, the expander control unit 156 executes Step S231. Conversely, when the expander control unit 156 determines that all the hard disks 151a˜151n operate in the normal operating mode, the expander control unit 156 returns to Step S233.

In Step S231, the expander control unit 156 increases the spin rate of the hard disks 151a˜151n to the normal spin rate so as to enhance the performance of the hard disks 151a˜151n and returns to Step S201.

In Step S233, the expander control unit 156 determines whether the fans 152 operate in the low-speed operating mode with the fan speed detector 154. When the expander control unit 156 determines that the fans 152 operate in the low-speed operating mode, the expander control unit 156 executes Sep S235. Conversely, when the expander control unit 156 determines all the fans 152 do not operate in the low-speed operating mode, the expander control unit 156 executes Step S237.

In Step S235, the expander control unit 156 increases the rotational speeds of the fans 152 and cause the fans 152 to leave the low-speed operating mode. Then the expander control unit 156 returns to Step S201.

In Step S237, the expander control unit 156 detects whether a portion of the connections of the first transmission interface is turned off according to the data transmission state of the first transmission interface between the expander control unit 156 and the server 11.

When expander control unit 156 determines that the portion of the connections of the first transmission interface is turned off, the expander control unit 156 executes Step S239. Conversely, when all of the connections of the first transmission interface are turned on, the expander control unit 156 executes Step S241. In Step S239, the expander control unit 156 turns on all the connections on the first transmission interface, and then returns to step S201.

In Step S241, the expander control unit 156 determines whether the expander control unit 156 is operating in the low-frequency operating mode according to the operating frequency of the expander control unit 156 detected i.e., the switching frequency for data transfer between the server 11 and the hard disks 151a˜151n.

When the expander control unit 156 determines that the expander control unit 156 operates in the low-frequency operating mode, the expander control unit 156 executes Step S243. Conversely, when the expander control unit 156 the expander control unit 156 does not operate in the low-frequency operating mode, the expander control unit 156 executes step S201. In Step S243, the expander control unit 156 restores the operating frequency of the expander control unit 156 to enhance the data transfer rate between the server 11 and the hard disks 151a˜151n.

In summary, exemplary embodiments of the present disclosure provide a RAID storage device, a server system, and a power management method thereof. When the power consumption of the RAID storage device exceeds a maximum upper power consumption limit configured, the RAID storage device is automatically driven to enter a power-saving mode, which includes reducing the switching frequency of the hard disks, reducing the access frequency of the hard disks, and reducing the rotational speeds of the fans to reduce the power consumption of the RAID storage device. Additionally, when the power consumption of the RAID storage device is lower than a lower power consumption limit, the RAID storage device is operable to enhance the performance of the RAID storage device. Accordingly, the RAID storage device can fully and efficiently utilize the supplying power allocated by actively and dynamically configuring the operation mode. Thereby avoid unnecessary waste of supplying power and at the same time enable the RAID storage device to stably operate with power allocated.

Moreover, the upper consumption limit for the RAID storage device in the server system can be configured based on operational needs or the supplying power configuration, which not only can actively allocate the operating power to the storage system but also enabling the storage system under the same power allocated to expand the storage space by addition more RAID storage devices without affecting the operation of the storage system.

The above-mentioned descriptions represent merely the exemplary embodiments of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A Redundant Array of Independent Disks (RAID) storage device, comprising:
a plurality of hard disks;
a plurality of fans;
a power detector, configured for operatively detecting the power consumption of the RAID storage device; and
an expander control unit coupled to the hard disks, the fans, and the power detector, wherein the expander control unit has a power control application that enables a user to configure an upper power consumption limit; wherein when the power consumption of the RAID storage device exceeds the upper power consumption limit, the expander control unit executes a power management procedure so that the power consumption of the RAID storage device is lower than the upper power consumption limit.

2. The RAID storage device according to claim 1, wherein the power management procedure comprises:
detecting whether the power consumption of the RAID storage device exceeds the upper power consumption limit; and
when the power consumption of the RAID storage device exceeds the upper power consumption limit, sequentially executes a plurality of power-saving procedures until the power consumption of the RAID storage device is lower than the upper power consumption limit, wherein the power-saving procedures comprise:
reducing the operating frequency of the expander control unit to cause the expander control unit to enter a low-frequency operating mode;
reducing the rotational speeds of the fans to cause the fans to enter a low-speed operating mode;
reducing the spin rates of the hard disks to cause the hard disks to enter a low-speed operating state; and
causing the hard disk with the lowest access frequency to enter a standby state or a hibernation state based on the access frequency associated with each of the hard disks.

3. The RAID storage device according to claim 2, wherein the expander control unit further comprises:
an integrator circuit, configured for receiving an accessing signal from each of the hard disks and transmitting a frequency signal corresponding to the access frequency associated with each of the hard disks; and
a Serial-Attached Small Computer System Interface (SAS) expander coupled to the integrator circuit, and configured for determining the access frequency associated with each of the hard disks according to the frequency signal transmitted from the integrator circuit.

4. The RAID storage device according to claim 3, wherein the expander control unit further detects whether the upper power consumption limit has been adjusted, and the expander control unit executes the power management procedure according to the upper power consumption limit adjusted so that the power consumption of the RAID storage device is lower than the upper power consumption limit.

5. The RAID storage device according to claim 3, wherein the power control application is configured for enabling the user to correspondingly configure a system power limit for the RAID storage devices, wherein the user configures the upper power consumption limit according to the system power limit; wherein the upper power consumption limit is lower than the system power limit.

6. The RAID storage device according to claim 2, wherein the power management procedure further comprises:
when the power consumption of the RAID storage device is lower than a lower power consumption limit, executes a plurality of efficiency-enhancing procedures to enhance the performance of the RAID storage device, wherein the efficiency-enhancing procedures comprise:
waking up all of the hard disks operated in the standby mode or the hibernation mode;
increasing the spin rate of the hard disks being operated in the low-speed operating state;
increasing the rotational speeds of the fans being operated in the low-speed operating mode; and
restoring the operating frequency of the expander control unit when detected that the expander control unit operates in the low-frequency operating mode;
wherein when the power consumption of the RAID storage devices detected exceeds the upper power consumption limit during the execution of the efficiency-enhancing procedures, stops executing the efficiency-enhancing procedures.

7. The RAID storage device according to claim 6, wherein the expander control unit further detects whether the upper power consumption limit has been adjusted, and the expander control unit executes the power management procedure according to the upper power consumption limit adjusted so that the power consumption of the RAID storage device is lower than the upper power consumption limit.

8. The RAID storage device according to claim 6, wherein the power control application is configured for enabling the user to correspondingly configure a system power limit of the RAID storage devices, wherein the user configures the upper power consumption limit according to the system power limit; wherein the upper power consumption limit is lower than the system power limit.

9. The RAID storage device according to claim 1, wherein the hard disks are Serial-attached Small Computer System Interface (SAS) disks and the expander control unit comprises a SAS expander for controlling the data transfer between a server and the hard disks.

10. The RAID storage device according to claim 1, wherein the expander control unit further detects whether the upper power consumption limit has been adjusted, and the expander control unit executes the power management procedure according to the upper power consumption limit adjusted so that the power consumption of the RAID storage device is lower than the upper power consumption limit.

11. The RAID storage device according to claim 1, wherein the power control application is configured for enabling the user to correspondingly configure a system power limit of the RAID storage devices, wherein the user configures the upper power consumption limit according to the system power limit; wherein the upper power consumption limit is lower than the system power limit.

12. A server system, comprising:
a plurality of the Redundant Array of Independent Disks (RAID) storage devices; and
at least a server, coupled to the RAID storage devices;
wherein, each of the RAID storage devices is configured to have an upper power consumption limit for limiting the power consumption of each of the RAID storage devices, and each of the RAID storage devices comprises:
a plurality of hard disks;
a plurality of fans;
a power detector, configured for operatively detecting the power consumption of the RAID storage device; and
an expander control unit coupled to the hard disks, the fans, and the power detector, wherein the expander control unit has a power control application that enables a user to configure an upper power consumption limit associated with each RAID storage device;
wherein when the power consumption of the RAID storage device exceeds the respective upper power consumption limit, the expander control unit executes a power management procedure so that the power consumption of the RAID storage device is lower than the respective upper power consumption limit.

13. The server system according to claim 12, wherein the power management procedure comprises:
detecting whether the power consumption of the RAID storage device exceeds the respective upper power consumption limit; and
when the power consumption of the RAID storage device exceeds the respective upper power consumption limit, sequentially executes a plurality of power-saving procedures until the power consumption of the RAID storage device is lower than the respective upper power consumption limit, wherein the power-saving procedures comprise:
reducing the operating frequency of the expander control unit to cause the expander control unit to enter a low-frequency operating mode;
reducing the rotational speeds of the fans to cause the fans to enter a low-speed operating mode;
reducing the spin rates of the hard disks to cause the hard disks to enter a low-speed operating state; and
causing the hard disk with the lowest access frequency to enter a standby state or a hibernation state based on the access frequency associated with each of the hard disks.

14. The server system according to claim 13, wherein the expander control unit further comprises:
an integrator circuit, configured for receiving an accessing signal from each of the hard disks and transmitting a frequency signal corresponding to the access frequency associated with each of the hard disks; and
a Serial-attached Small Computer System Interface (SAS) expander coupled to the integrator circuit, and configured for determining the access frequency associated with each of the hard disks according to the frequency signal transmitted from the integrator circuit.

15. The server system according to claim 14, wherein the expander control unit further detects whether the upper power consumption limit has been adjusted, and the expander control unit executes the power management procedure according to the upper power consumption limit adjusted so that the power consumption of the RAID storage device is lower than the respective upper power consumption limit.

16. The server system according to claim 14, wherein the power control application is configured for enabling the user to correspondingly configure a system power limit for each of the RAID storage devices, wherein the user configures the upper power consumption limit for each respective RAID storage device according to the respective system power limit; wherein each of the upper power consumption limits is lower than the respective system power limit.

17. The server system according to claim 13, wherein the power management procedure further comprises:
when the power consumption of the RAID storage device is lower than a respective lower power consumption limit configured therefor, execute a plurality of efficiency-enhancing procedures to enhance the performance of the RAID storage device, wherein the efficiency-enhancing procedures comprise:
waking up all of the hard disks operated in the standby mode or the hibernation mode;
increasing the spin rate of the hard disks being operated in the low-speed operating state;
increasing the rotational speeds of the fans being operated in the low-speed operating mode; and
restoring the operating frequency of the expander control unit when detected that the expander control unit operates in the low-frequency operating mode;
wherein, when the power consumption of the RAID storage devices detected exceeds the respective upper power consumption limit during the execution of the efficiency-enhancing procedures, stops executing the efficiency-enhancing procedures.

18. The server system according to claim 17, wherein the expander control unit further detects whether the upper power consumption limit has been adjusted, and the expander control unit executes the power management procedure according to the upper power consumption limit adjusted so that the power consumption of the respective RAID storage device is lower than the respective upper power consumption limit.

19. The server system according to claim 17, wherein the power control application is configured for enabling the user to correspondingly configure a system power limit for each of the RAID storage devices, wherein the user configures the upper power consumption limit for each respective the RAID storage device according to the respective system power limit; wherein each of the upper power consumption limits is lower than the respective system power limit.

20. The server system according to claim 12, wherein the hard disks are Serial-attached Small Computer System Interface (SAS) disks and the expander control unit comprises a SAS expander for controlling the data transfer between the server and the hard disks.

21. The server system according to claim 12, wherein the control application is stored in the expander control unit and the control application is configured for configuring a lower power consumption limit associated with the respective RAID storage device and executing a plurality of power-saving procedures.

22. The server system according to claim 12, wherein the expander control unit further detects whether the upper power consumption limit has been adjusted, and the expander control unit executes the power management procedure according to the upper power consumption limit adjusted so that the power consumption of the respective RAID storage device is lower than the respective upper power consumption limit.

23. The server system according to claim 12, wherein the power control application is configured for enabling the user to correspondingly configure a system power limit for each of the RAID storage devices, wherein the user configures the upper power consumption limit for each respective RAID storage device according to the respective system power limit; wherein each of the upper power consumption limits is lower than the respective system power limit.

24. A power management method of a Redundant Array of Independent Disks (RAID) storage device, wherein the RAID storage device comprises a plurality of hard disks, a plurality of fans, a power detector, and an expander control unit, the power management method comprising:
providing a power control application to enable a user to configure an upper power consumption limit, wherein the power control application is stored in the expander control unit;
detecting whether the power consumption of the RAID storage device exceeds the upper power consumption limit; and
when the power consumption of the RAID storage device exceeds the upper power consumption limit, the expander control unit executes a power management procedure so that the power consumption of the RAID storage device is lower than the upper power consumption limit.

25. The power management method according to claim 24, wherein the power management procedure comprises:
detecting whether the power consumption of the RAID storage device exceeds the upper power consumption limit; and
when the power consumption of the RAID storage device exceeds the upper power consumption limit, sequentially executes a plurality of power-saving procedures until the power consumption of the RAID storage device is lower than the upper power consumption limit, wherein the power-saving procedures comprise:
reducing the operating frequency of the expander control unit to cause the expander control unit to enter a low-frequency operating mode;
reducing the rotational speeds of the fans to cause the fans to enter a low-speed operating mode;
reducing the spin rates of the hard disks to cause the hard disks to enter a low-speed operating state; and
causing the hard disk with the lowest access frequency to enter a standby state or a hibernation state based on the access frequency associated with each of the hard disks.

26. The power management method according to claim 25, wherein the power management procedure further comprises:
when the power consumption of the RAID storage device is lower than a lower power consumption limit, executes a plurality of efficiency-enhancing procedures to enhance the performance of the RAID storage device, wherein the efficiency-enhancing procedures comprise:
waking up all of the hard disks operated in the standby mode or the hibernation mode;
increasing the spin rate of the hard disks being operated in the low-speed operating state;
increasing the rotational speeds of the fans being operated in the low-speed operating mode; and
restoring the operating frequency of the expander control unit when detected that the expander control unit operates in the low-frequency operating mode;
wherein, when the power consumption of the RAID storage devices detected exceeds the upper power consumption limit during the execution of the efficiency-enhancing procedures, stops executing the efficiency-enhancing procedures.

27. The power management method according to claim 26, wherein the step of configuring the upper power consumption limit comprises:
configuring a system power limit for the RAID storage device; and
configuring the upper power consumption limit according to the system power limit, wherein the upper power consumption limit is lower than the system power limit.

28. The power management method according to claim 24, wherein the step of configuring the upper power consumption limit comprises:
configuring a system power limit for the RAID storage devices; and
configuring the upper power consumption limit according to the system power limit, wherein the upper power consumption limit is lower than the system power limit.
